(19) United States
(12) Patent Application Publication
(10) Pub. No.: US 2009/0133123 A1
(43) Pub. Date: May 21, 2009

(54) Worm Propagation Modeling In A Mobile AD-HOC Network

(75) Inventors: Hayder Radha, East Lansing, MI (US); Syed Ali Khayam, East Lansing, MI (US)

Correspondence Address: HARNESS, DICKEY & PIERCE, P.L.C., P.O. BOX 828, BLOOMFIELD HILLS, MI, 48303, US

(73) Assignee: Board of Trustees of Michigan State University, East Lansing, MI (US)

(21) Appl. No.: 11/921,330

(22) PCT Filed: Jun. 2, 2006
(86) PCT No.: PCT/US2006/021501

§ 371 Date: Nov. 30, 2007

Related U.S. Application Data
(60) Provisional application No. 60/687,512, filed on Jun. 3, 2005.

(51) Int. Cl. G06F 21/00; G06G 7/62; G06F 17/10

(52) U.S. Cl. 726/24; 703/22; 703/2

(57) ABSTRACT

A worm propagation modeling system for use with a mobile ad-hoc network (MANET) includes an infection detection module receiving temporal dynamics information relating to temporal dynamics of worm spread in the MANET and spatial dynamics information relating to spatiality of nodes in the MANET. The infection detection module detects infection in a network segment of the MANET based on the temporal dynamics information and the spatial dynamics information.

### FIELD OF THE INVENTION

The present invention generally relates to worm propagation modeling, and relates in particular to a system and method for modeling worm propagation in large-scale mobile ad hoc networks (MANET).

### BACKGROUND OF THE INVENTION

Active computer worms, which spread over a network without human intervention, have recently emerged as one of the most imminent and effective threats against information confidentiality, integrity and service availability. In particular, the last few years have witnessed a dramatic increase in malicious Internet traffic. Active worms have repeatedly revealed the susceptibility of Internet hosts to malicious intrusions by compromising millions of vulnerable Internet hosts at an extremely fast pace, thereby eluding human counter-measures. While most contemporary worms have used the compromised hosts to launch distributed denial-of-service (DDOS) attacks and/or cause damage to personal computers, in view of their rapid evolution it is predicted that future worms will, in addition to being more virulent, pose more serious threats, such as access to or corruption of sensitive information. The evolving nature and the consequent threats posed by these self-propagating adversaries necessitate the development of real-time defense systems that can promptly and effectively detect the spread of active worms.

An accurate worm propagation model is instrumental for real-time detection and mitigation of worm propagation. Therefore, many classical and recent studies have proposed worm propagation models for Internet worms. While Internet monitoring and worm detection strategies are now being proposed, it is important that designers of emerging computer networks preemptively cater for worm detection and mitigation. Large-scale mobile ad hoc networks (MANET) are among such emerging networks.

Design of MANET for deployment in various distributed wireless scenarios (such as vehicular ad hoc networks (VANET), military communications etc.) is currently underway. The safety-related and time critical natures of many MANET applications necessitate a robust security framework. An active worm over a MANET can, in addition to the well-known threats, pose a whole new class of threats. For instance, worms over VANET can cause traffic-related threats ranging from congestion to large scale accidents. Thus, design of secure MANET applications should consider real-time monitoring, detection and mitigation of worms. An accurate model is necessary to detect and curb propagation of active worms over MANET.

Previous studies have applied the simple Kermack-McKendrick epidemic model to worm propagation modeling over the Internet. These studies have established that the spread of an Internet worm (i.e., the total number of compromised hosts) can be divided into three distinct phases: (1) an exponential start phase followed by (2) a linear spread phase concluding with (3) a slow finish phase. The exponential initial spread is due to the availability of large numbers of vulnerable hosts on the Internet. As time progresses, more and more susceptible Internet hosts are infected and therefore the curve assumes a linear increase. The slow final spread in the Internet is attributed to the fact that it takes more time to search out the few remaining vulnerable hosts.

While previous studies have established the efficacy of the epidemic model in capturing the time dynamics of Internet worms, the spatiality of MANET nodes necessitate a more sophisticated modeling strategy than the simple Kermack-McKendrick model. Previous work, such as reported in C. C. Zou, L. Gao, W. Gong and D. Towsley, “Modeling and Early Warning for Internet Worms,” ACM Conference on Computer and Information Security (CCS), 2003 does not provide a worm model that accounts for underlying characteristics of MANET that can impact spread dynamics of an unknown (zero-day) worm. The present invention fulfills this need.

### SUMMARY OF THE INVENTION

In accordance with the present invention, a worm propagation modeling system for use with a mobile ad-hoc network (MANET) includes an infection detection module receiving temporal dynamics information relating to temporal dynamics of worm spread in the MANET and spatial dynamics information relating to spatiality of nodes in the MANET. The infection detection module detects infection in a network segment of the MANET based on the temporal dynamics information and the spatial dynamics information.

Due to the evolving nature of worms, it is important that the worm detection module makes few, if any, assumptions about the characteristics of a worm. Such a detection module has to rely on generic propagation characteristics of that are common to all worms. To that end, a parameterized propagation model is provided in this document. The detection module can periodically monitor the spread of a particular packet over the MANET. A worm detection alarm can be raised if the spread characteristics of the packet are similar to those predicted by the propagation model.

The worm propagation models according to the present invention are advantageous over previous worm propagation models. For example, they account for underlying characteristics of MANET that can impact spread dynamics of an unknown (zero-day) worm. Specifically, they anticipate the effects of channel contention, effective virulence strategies, node density, transmission ranges and mobility on MANET worm propagation. A one-dimensional propagation model (OWPM) borrows its basic formulation from models of epidemic diseases. However, the advanced model parameters and mathematical treatment following the formulation are developed specifically for a one-dimensional MANET. The basic model formulation results in a partial differential equation which is solved in the frequency domain to yield a closed-form solution for the OWPM. The OWPM has proven its performance by simulation of the spread of a worm over a one-dimensional MANET. Comparison of the simulated and the OWPM-predicted worm propagation dynamics demonstrate the ability of the OWPM to predict worm propagation dynamics with outstanding accuracy. The closed-form expression for the two-dimensional propagation model (TWPM) obtained using similar derivations as the OWPM also exhibits, by comparison to simulation results, demonstrable ability to capture two-dimensional worm spread dynamic quite accurately.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1A is a perspective diagram illustrating a MANET in accordance with the present invention;

FIG. 1B is a diagram illustrating spatial segmentation of a one-dimensional MANET in accordance with the present invention;

FIG. 2 is a two-dimensional graph illustrating a total number of infected MANET nodes given by a simulation employing a one-dimensional worm propagation model (OWPM) in accordance with the present invention, wherein the graph has total infected nodes of the network on the ordinate axis, and normalized time on the abscissa;

FIG. 3 is a two-dimensional graph illustrating a total number of infected MANET nodes in segment, ξ=145 given by the simulation employing the OWPM in accordance with the present invention, wherein the graph has total infected nodes of the segment on the ordinate axis, and normalized time on the abscissa;

FIG. 4 is a diagram illustrating spatial segmentation of a two-dimensional MANET in accordance with the present invention;

FIG. 5 is a two-dimensional graph illustrating a total number of infected MANET nodes given by a simulation employing a two-dimensional worm propagation model (TWPM) in accordance with the present invention, wherein the graph has total infected nodes of the network on the ordinate axis, and normalized time on the abscissa; and

FIG. 6 is a two-dimensional graph illustrating a total number of infected MANET nodes in segment (ξ=49, η=49) given by the simulation employing the OWPM in accordance with the present invention, wherein the graph has total infected nodes of the segment on the ordinate axis, and normalized time on the abscissa.

### DETAILED DESCRIPTION OF THE PREFERRED EMBODIMENTS

The following description of the preferred embodiments is merely exemplary in nature and is in no way intended to limit the invention, its application, or uses.

A worm is a program or algorithm that replicates itself over a computer network and usually performs malicious actions, such as using up the computer's resources, possibly shutting the system down, corrupting information on the system (which in certain cases such as the Witty worm made the system unusable), and launching denial-of-service attacks at important websites. A worm is similar to a virus by its design, and is considered to be a sub-class of a virus. A worm spreads from computer to computer, but unlike a virus, it has the ability to travel without any help from a person. A worm takes advantage of file or information transport features on a system, which allows it to travel unaided. Furthermore, a worm exploits buffer-overflow vulnerabilities in commonly used services and hence has the ability to self-trigger after infecting a computer. Consequently, a user need not even be present at the infected computer for a worm to execute. Lastly, one big danger with a worm is its ability to replicate itself on a system, so rather than a computer sending out a single worm, it can send out hundreds or thousands of copies of itself, creating a huge devastating effect. Due to the copying nature of a worm and its ability to travel across networks, the end result in most cases is that the worm consumes too much system memory (or network bandwidth), causing Web servers, network servers, and individual computers to stop responding. In some worm attacks, such as the Blaster Worm, the worm has been designed to tunnel into a system and allow malicious users to control the infected system remotely.

Since design and deployment of large-scale ad hoc networks is still in its infancy, it is important to characterize what can be expected from worms designed specifically for mobile networks. Accordingly, the worm propagation modeling technique is developed in the context of MANET worm propagation characteristics. Since detection and spread prevention of a known worm can be achieved easily by signature-based detection techniques, the efforts at anticipation of MANET worm propagation characteristics focus on unknown worms, also known as zero-day worms and novel worms. Accordingly, attention is focused on determining what characteristics of MANET can impact the spread of an unknown worm.

A first characteristic of MANET that can impact the spread of an unknown worm relates to medium access constraints. For example, Internet studies have emphasized that the payload of an infectious probe packet is generally small. Furthermore, the worm starts many threads after it compromises a host (Code Red v2 opened up to 600 threads to probe other vulnerable machines). However, as opposed to the Internet, worms over MANET will face channel contention which may reduce the overall rate of spread. Depending on the node density and Medium Access Control (MAC) layer fairness, the highest achievable probe rate might be significantly lower than the rate achievable over the Internet. A similar trend was observed for the Internet in previous studies. It was shown that after the initial fast spread phase, worm traffic causes severe congestion at routers and hence the spread rate decreases. Future worms will have to use better scanning techniques in order to achieve high virulence. In view of the above discussion, it can be inferred that MANET worms may be more bandwidth and contention aware than Internet worms. Thus, efficient spreading techniques are likely to be employed by MANET worms. One such technique relates to next-hop scanning.

Most contemporary Internet worms uniformly scan the IP address space; in other words, every IP address in the 2³² IPv4 space has an equal probability of being probed. This results in many “missed scans” due to two reasons: (1) the unused IP address space; (2) many of the uniformly scanned computers are already patched. Previous studies have discussed strategies that can increase the virulence of an Internet worm. One such strategy that has been effectively employed by many recent worms (e.g., CodeRed v2) is localized scanning. The local scanning worms after compromising a host scan the nearby hosts (e.g., machines in the same subnet) with a higher probability. This strategy has proven to be quite effective since presence of a single vulnerable host implies that with high probability other hosts on the same network will also be vulnerable. This method increases virulence while reducing the outgoing network traffic. Nevertheless, even localized scanning suffers from unused IP address scans.

In the localized scanning context, a MANET worm has an invaluable resource available to it in the form of its next-hop neighbor list. Ad hoc routing algorithms ensure that a next-hop neighbor list is maintained, or can be generated quickly, at each node. An infectious MANET node can spread the infection quite effectively by communicating it only to its next-hop neighbors. This strategy, referred to herein as next-hop scanning, will provide effective worm propagation with minimal channel contention delays. Hence, the worm propagation models presented below are developed in part in view of the assumption that a MANET worm employs the next-hop infection strategy.

Other characteristics of MANET that can impact the spread of an unknown worm relate to node density, transmission range, and mobility. For example, the number of neighbors of a node is directly proportional to both its transmission range and the node density in the MANET. Hence, it can be easily deduced that the propagation speed of a next-hop scanning worm will also be directly proportional to the transmission range and node density. However, mobility of nodes in any MANET and in particular VANET nodes which travel at high velocities raises questions as to whether node mobility will impact worm propagation.

In attempting to answer this question, it is reasonable to assume that mobility will not have a significant effect on the MANET worm propagation because relative velocities of MANET nodes are not very high. For example, consider a mobile node which moves from a current MANET segment to a new segment. Due to the low relative velocity, and due in part to the high next-hop virulence, by the time the node reaches the next segment, infection would already have started there. In other words, it is probable that the time scale at which next-hop scanning worms propagate over MANET nodes is much smaller than the time scale at which a mobile node changes its position relative to other nodes in practical ad hoc systems (e.g., vehicles in a small segment of a highway). Analysis and simulation results provided below verify this probability. Thus, the worm propagation models presented below are developed in part based on the assumption that the mobility of a node does not contribute much to the overall infection propagation. An accurate mobility model can nevertheless be incorporated in the present propagation model quite easily.

The essential, expected propagation characteristics of a MANET worm and the consequent assumptions can be summarized as follows: (1) in view of the channel contention constraints, MANET worms employ the next-hop scanning strategy; (2) the total number of infected nodes is directly proportional to the MANET node density and transmission ranges of MANET nodes; and (3) the mobility of MANET nodes does not have a significant impact on propagation dynamics of a MANET worm. Immediately below, the assumptions developed from these observations are employed to define the one-dimensional worm propagation model.

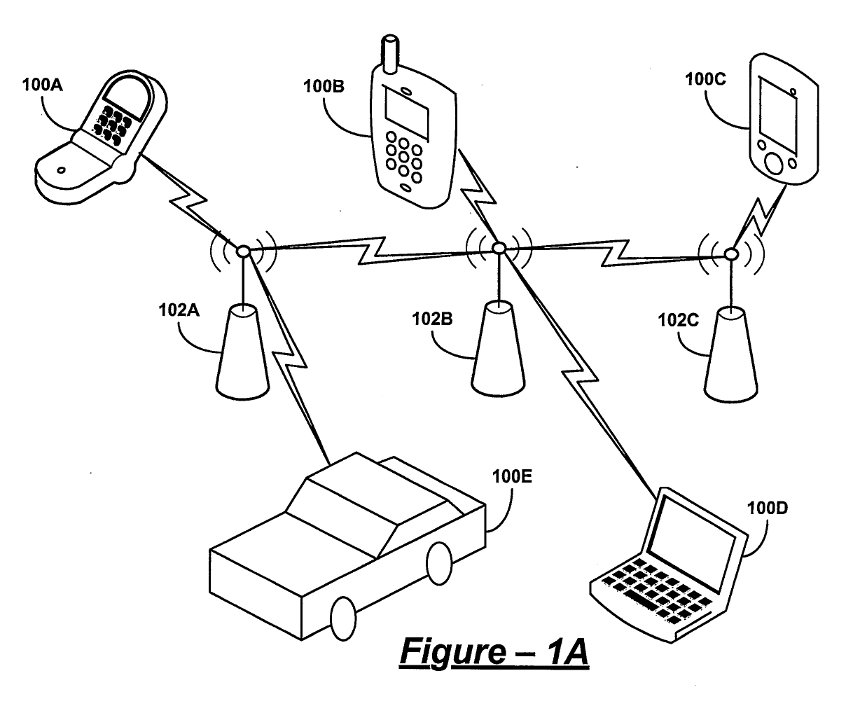

Referring to FIG. 1A, nodes of a MANET can be stationary and/or mobile devices 100A-100E, such as wireless network enabled cell phones, smart phones, personal digital assistants, vehicle navigation systems, laptops, and other devices. Nodes of the network can also be access points 102A-102C that may be stationary and/or mobile. The spatiality of such a network can be continuously changing. However, the network can be spatially segmented permanently or dynamically. This segmentation is merely logical in nature, with the only constraint that the area of a segment is significantly less than the transmission range of the mobile nodes in the segment.

Turning now to FIG. 1B, a one-dimensional worm propagation model is developed for an ad hoc network that has node distribution that is much greater in the horizontal axis than in the vertical axis. Such one-dimensional node distribution is generally encountered in vehicular ad hoc networks, termed VANET, which are a type of MANET. The worm propagation model thus derived for a one-dimensional MANET is referred to as the one-dimensional worm propagation model (OWPM).

As mentioned earlier, for the one-dimensional MANET nodes are placed on a two dimensional grid which has a horizontal axis that is much larger than the vertical axis. Let N nodes be placed uniformly on such a two-dimensional spatial grid as shown in FIG. 1B. Note that, while location of each node is represented by its two dimensional coordinates, nodes move only over the horizontal axis which is represented by ξ. The horizontal axis is hence sampled into n equal sized segments. Since the nodes are distributed uniformly over the grid, each grid segment contains N/n nodes.

The spatial demarcation (into equal sized segments) described above is intentionally kept rather simple and abstract to facilitate the simulation of presented models. Dependence on channel/traffic parameters (such as quality of physical link between nodes, number and power of transmit/receive antennas, traffic characteristics, etc.) is therefore avoided. Nevertheless, the model should account for nodes on the border of each segment. These nodes communicate with border nodes of neighboring segments and are quite important since the infection spreads across segments through these border nodes.

A closer look at FIG. 1B reveals that in the one dimensional MANET, the border nodes in any segment ξ, except the edge segments (ξ=1 and ξ=n), will either communicate with the segment on their left, ξ−1, or with the segment on their right, ξ+1. Here, two realistic assumptions are made: (1) half of the border nodes communicate with the segment ξ−1, while the remaining half communicate with segment ξ+1; and (2) the total size of the ξ axis (i.e., the total length of the one-dimensional MANET) is large enough so that the edge effects, which arise because the first and last segments have only one neighbor, are mitigated.

In order to simultaneously capture spatiality and time dynamics of a one dimensional MANET, the worm propagation model in this section is defined with respect to two independent variables, namely the spatial position of nodes, ξ, and time, t, where ξ is a discrete variable whereas t is a continuous variable. Similarly, a model for a two-dimensional MANET is provided below (i.e., two parameters are needed to completely specify the location of a node). Since these models simultaneously capture the spatiality and time dynamics of worm propagation, they are generically referred to as space-time models. The formulation and derivation of the one-dimensional worm propagation model (OWP) is provided immediately below.

As outlined above, these models focus solely on propagation dynamics of unknown worms; therefore, a node can be in one of two possible states: (a) susceptible; or (b) infected. A susceptible node becomes infected as soon as it is contacted by an infectious node. Immediately after getting infected, a node starts spreading the worm. Let the total number of susceptible and infectious nodes in the spatial segment, ξ, at time, t, be denoted by S(ξ,t) and I(ξ,t), respectively. Since the total number of nodes in a segment is constant, the sum of nodes in both states should be

S(ξ,t)+I(ξ,t)=N/n. (1)

This model is referred to as the classical SI model of epidemic diseases in previous studies. A somewhat advanced version of this model incorporates a removed state which contains infectious individuals that either become immune to the infection or die because of the infection. In the MANET scenario, the removed state would correspond to infectious nodes that have been patched. However, due to the high virulence and the unknown nature of the next-hop worm, by the time a patch reaches an infectious node all of its vulnerable neighbors are likely to be infected already.

It is also assumed herein that the total population of initially susceptible nodes is large enough so that during the initial stages of the worm spread, the susceptible population is approximately constant. Let β represent a constant infection rate, where 0<β≦1. More specifically, an infectious node infects βS(ξ,t) susceptible nodes in one unit of time. Thus, I(ξ,t) infectious nodes create a total of βS(ξ,t)I(ξ,t) new infections in each time unit.

Let the rate of infectious contacts received by border notes of a spatial segment, ξ, be denoted as φ. As mentioned previously, half of the border nodes in segment ξ will communicate with the segment on the left, ξ−1, while the other half will communicate with the segment on the right, ξ+1. The rate of change of susceptible population with respect to time can then be expressed as

$$\frac{\partial S ( ξ , t )}{\partial t} = - β S ( ξ , t ) I ( ξ , t ) . \qquad ( 2 )$$

The partial differential equation given in (2), characterizes the reduction in the susceptible population because of βS(ξ,t)I(ξ,t) new infections. Similarly, the rate of change in the infectious population is

$$\frac{\partial I ( ξ , t )}{\partial t} = β S ( ξ , t ) I ( ξ , t ) - φ ( \frac{I ( ξ - 1 , t ) + I ( ξ + 1 , t )}{2} ) . \qquad ( 3 )$$

The

$$φ ( \frac{I ( ξ - 1 , t ) + I ( ξ + 1 , t )}{2} )$$

term in (3) captures the number of infections contracted from the infectious border nodes of neighboring segments.

Now that the fundamental equations have been defined, it is possible to focus on obtaining a closed-form solution for the above model. Previous studies of Internet worm epidemics have outlined that the spread is exponential during the initial stages. Therefore, ascertaining the solution for I(ξ,t) during initial stages of the worm outbreak is of particular interest. The closed-form solution is derived immediately below.

Before proceeding with the solution of the expression given in (3), it is first appropriate to reiterate the initial assumption that the total population of initially susceptible nodes, given by N/n, is large enough so that during the initial stages of the worm spread the susceptible population is approximately constant. Then, (3) can be rewritten as

$$\frac{\partial I ( ξ , t )}{\partial t} = β \frac{N}{n} I ( ξ , t ) + φ ( \frac{I ( ξ - 1 , t ) + I ( ξ + 1 , t )}{2} ) . \qquad ( 4 )$$

Let

$$A = β \frac{N}{n}$$

and B=φ. Then (4) takes the following form

$$\frac{\partial I ( ξ , t )}{\partial t} = AI ( ξ , t ) + B ( \frac{I ( ξ - 1 , t ) + I ( ξ + 1 , t )}{2} ) .$$

To solve this partial differential equation, a one-dimensional Fourier transform is taken along the ξ axis. Recall that ξ is a discrete variable and in order to find its discrete-time Fourier transform (DTFT), the above equation is multiplied with e^{-jωξ} followed by a summation on ξ

$${\sum }_{ξ} \frac{\partial I ( ξ , t )}{\partial t} {e}^{- j ω ξ} = {\sum }_{ξ} AI ( ξ , t ) {e}^{- j ω ξ} + {\sum }_{ξ} B ( \frac{I ( ξ - 1 , t ) + I ( ξ + 1 , t )}{2} ) {e}^{- jωξ} .$$

Changing the order of the summation and differentiation on the left-hand side of the above equation gives

$$\frac{\partial }{\partial t} {\sum }_{ξ} I ( ξ , t ) {e}^{- j ω ξ} = A {\sum }_{ξ} I ( ξ , t ) {e}^{- j ω ξ} + B {\sum }_{ξ} ( \frac{I ( ξ - 1 , t ) + I ( ξ + 1 , t )}{2} ) {e}^{- j ω ξ} .$$

Using M(ω,t) to denote the DTFT of I(ξ, t) obtains

$$\frac{\partial }{\partial t} M ( ω , t ) = AM ( ω , t ) + B ( \frac{{e}^{j ω} + {e}^{- j ω}}{2} ) M ( ω , t ) .$$

Replacing the (e^{jω}+e^{-jω})/2 term with cos(ω) results in

$$\frac{\partial }{\partial t} M ( ω , t ) = ( A + B cos ( ω ) ) M ( ω , t ) . \qquad ( 5 )$$

The above expression is of the form

$$\frac{d}{d x} f ( x ) = Cf ( x )$$

and has a solution in f(x)=De^{Cx}. Using this result for (5) obtains,

M(ω,t)=De^{(A+Bcos(ω))t} (6)

where, D has to be solved with respect to the initial condition, M(ω,0), in order to get the complete solution. Note however that the solution for D cannot be determined in the frequency domain directly and, therefore, one must resort back to the ξ domain. Without loss of generality, it is assumed that the worm outbreak starts with a single infectious node in an arbitrary segment, ξ=H. Hence, at time t=0 there is only one infected node in the MANET located in segment ξ=H, i.e., I(ξ,0)=δ(ξ−H,0) where δ(.,.), represents an impulse function. The value of D is then easily computed as

$$M ( ω , 0 ) = {\sum }_{ξ} I ( ξ , 0 ) {e}^{- j ω ξ} = {\sum }_{ξ} δ ( ξ - H , 0 ) {e}^{0} = 1 = D .$$

Thus, the complete solution for (6) is

M(ω,t)=e^{(A+Bcos(ω))t}. (7)

Since t is invariant under the current Fourier transformation, the inverse transform will again be with respect to ω only, with t being treated as a constant. Thus to simplify the representation, (7) can be rewritten as

M(ω,t)=e^{At}e^{Btcos(ω)}

or

$$\tilde{M} ( ω ) = E {e}^{\frac{1}{F} cos ( ω )} ,$$

where \tilde{M}(ω)≡M(ω,t),E=e^{At} and

$$\frac{1}{F} = Bt .$$

The function

$${e}^{\frac{1}{F} cos ( ω )}$$

is mathematically cumbersome. Thus, it is easier to employ its Taylor series approximation

$${e}^{cos ( ω )} = {e}^{\frac{1}{F} ( 1 - \frac{{ω}^{2}}{2 !} + \frac{{ω}^{4}}{4 !} - \frac{{ω}^{6}}{6 !} + … )} .$$

Using the first two terms of the above expansion, an approximation of

$$\tilde{M} ( ω ) \approx E {e}^{\frac{1}{F} ( 1 - \frac{{ω}^{2}}{2} )} .$$

Now, the inverse transformation is

$$\tilde{I} ( ξ ) \approx \frac{1}{2 π} \int E {e}^{\frac{1}{F} ( 1 - \frac{{ω}^{2}}{2} )} {e}^{j ξ ω} d ω \\ \approx E {e}^{\frac{1}{F}} \frac{1}{2 π} \int {e}^{- \frac{{ω}^{2}}{2 F}} {e}^{jξω} d ω .$$

The above expression denotes the inverse Fourier transform of a Gaussian function. The forward Fourier transform of the Gaussian function

$${e}^{\frac{{ξ}^{2}}{2 F}}$$

is given by

$${\sqrt{2 π F e}}^{- F \frac{{w}^{2}}{2}} .$$

By duality, the following expression is obtained

$$\sqrt{\frac{F}{2 π}} {e}^{- F ξ \frac{2}{2}} {}^{DTFT} {e}^{- \frac{{ω}^{2}}{2 F}} \qquad ( 8 )$$

The complete expression for Ĩ(ξ) is then given by

$$\tilde{I} ( ξ ) \approx E {e}^{\frac{1}{F}} {\sqrt{\frac{F}{2 π} e}}^{- F ξ \frac{2}{2}}$$

Plugging in the values of A, B, E and F renders the final (approximate) closed-form expression for Ĩ(ξ)≡I(ξ,t) as

$$I ( ξ , t ) \approx \frac{1}{\sqrt{2 π φ t}} {e}^{( β \frac{N}{n} + φ ) t} {e}^{- \frac{{ξ}^{2}}{2 φ t}} \qquad ( 9 )$$

The above closed-form solution for OWPM describes the spread of a computer worm in a one-dimensional MANET. The term

$${e}^{( β \frac{N}{n} + φ ) t}$$

in (9) is congruent with previous studies, which use worm propagation traces collected over the Internet to illustrate that the worm spreads exponentially during the initial phase. In particular, the expression according to the previous studies shows that the initial spread is an exponential function of the infection rate, β, and the node density, N/n, in the current segment. The e^{φt} term emphasizes that the number of infectious contacts, φ, received from border nodes of neighboring segments further expedite the infection process in the current segment. The expression

$${e}^{\frac{- {ξ}^{2}}{2 φ t}}$$

exponentially decreases with an increase in ξ. This result is intuitive since nodes which are spatially far away from the infectious concentration are much less likely to contract infections. Thus, the number of infectious nodes in a segment ξ is a function of its distance from the infectious concentration.

Simulation results verifying the correctness of the obtained closed form solution are detailed immediately below. The shortcomings of traditional network simulators for worm propagation simulations have been emphasized in previous studies. These worm simulation studies eventually resorted to developing their own simulators. However, those simulators were designed specifically for Internet worms, and are therefore not useful for MANET worm spread simulations. As a result, a simple MANET simulator was developed to abstractly simulate worm traffic over a MANET.

Given the total number of nodes and a two-dimensional grid size, the simulator uniformly places the nodes on the grid. Once transmission range of each node is specified, the simulator calculates the next-hop neighbors using the Euclidean distance measure. Specifically, all nodes which are at a Euclidean distance less than or equal to the transmission range of a node are defined as its next-hop neighbors. Such a geometric graph allowed abstract simulations of MANET worm propagation. In accordance with previous discussion above, the nodes maintain their respective coordinates during the course of a simulation.

The constant infection rate, β, and the first infectious node are the only worm-based parameters given as input to the simulator. At each time instance, every infected node communicates the infection to β fraction of its susceptible neighbors. The simulator generates worm propagation traces for a total number of infected nodes in the grid. Moreover, if segment sizes on the horizontal and vertical axes are specified, the simulator also generates traces for total number infected nodes in each grid segment.

For the one-dimensional MANET, a grid of size 16000×18 m² and a transmission range of 10 m were used. The total number of nodes was set to N=8000. An infection rate of β=0.2 was used for the simulation. A segment size of 100 m was specified for the horizontal axis, i.e., 1≦ξ≦160. Due to the uniform node distribution, the sub-division of the horizontal axis results in approximately 50 nodes per grid segment.

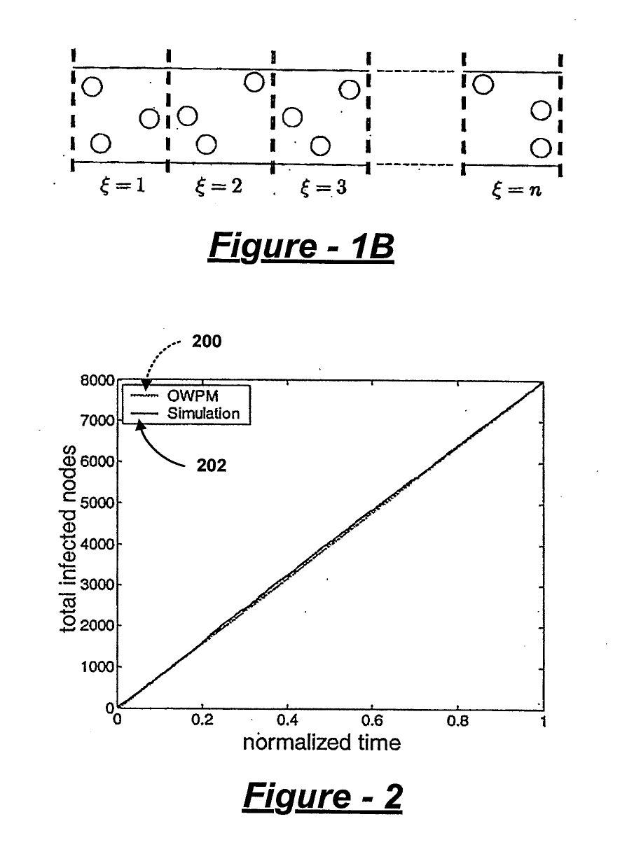

Referring to FIG. 2, the spread pattern predicted by the model used the same N,β and ξ as the simulator. The infectious contacts from border were specified by φ=0.4. The total number of infected nodes given by the OWPM model 200 and the simulation 202 (the results are plotted against the respective normalized times of the OWPM-predicted and simulated worm propagations). It is clear that the model follows the simulated propagation pattern remarkably closely. Both model-based and simulated propagations take the same amount of time to compromise all hosts in the MANET. It is deduced that at all time instances, the model predicts the total number of infected nodes extremely accurately. Such performance of the proposed OWPM model ascertains that it is an effective model of one-dimensional MANET worm propagation.

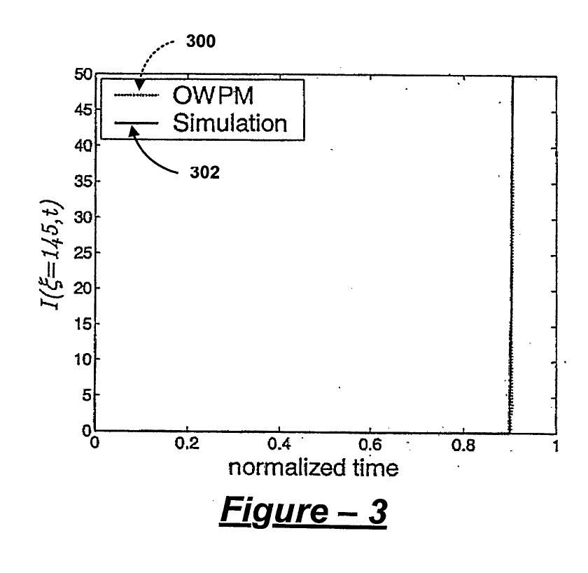

Recall that the spread of an Internet worm is divided into three phases: (1) an exponential start phase followed by (2) a linear spread phase concluding with (3) a slow finish phase. From FIG. 2, it can be observed that the total number of infections in a MANET increase linearly with time which is quite different from the three phase pattern for Internet worms. This result is intuitive since, unlike most Internet worms, MANET worms spread in a spatial fashion. Thus, grid segments that are farther away from infection concentration will contract the infection after a long delay. This phenomenon is clearly depicted in FIG. 3, which gives the total number of infectious nodes in spatial segment ξ=145 for the OWPM 300 and the simulation 302. The total number of infections is equal to zero for approximately 90% of the propagation time. However, as soon as the first node in segment ξ=145 gets infected, the remaining nodes are infected very quickly. It can also be observed from FIG. 3 that OWPM matches the simulated results for the spread of the worm in segment ξ=145.

The two-dimensional worm propagation model is obtained by extending the analysis and derivations detailed above to a two-dimensional MANET. The resulting model is referred to as the two-dimensional worm propagation model (TWPM). Similar to the one-dimensional case, N nodes are uniformly placed on a two-dimensional spatial grid. However, unlike the one-dimensional scenario where one axis was much larger than the other, here the sizes of the horizontal and the vertical axes are comparable. These horizontal and vertical axes are represented herein by ξ and η, respectively. Both axes are in turn sampled into segments. Let p and q be the total number of segments along ξ and η, respectively. Since the nodes are distributed uniformly over the grid, each grid segment contains N/pq nodes.

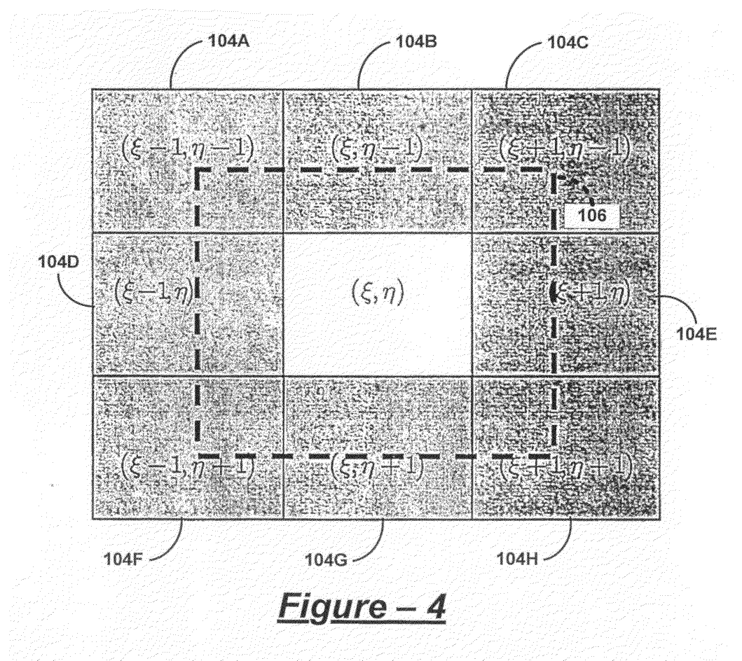

FIG. 4 shows that border nodes of all the segments, except the segments on the periphery of the grid, will now communicate with border nodes of eight neighboring segments. These neighboring segments are shown as boxes 104A-104H in FIG. 4. It is assumed that the infection spreads through nodes located around the borders of a segment (ξ,η). Thus, due to the uniform node distribution, the region from which infection is contracted is the inside of region 106 in FIG. 4.

For uniformly distributed nodes, infection is spread through 25% of infected nodes of segments (ξ−1,η−1), ξ+1,η−1, (ξ−1,η+1) and (ξ+1,η+1). Similarly, 50% of infected nodes of segments (ξ,η−1), (ξ−1,η), (ξ+1,η−1) and (ξ,η+1) will be located adjacent to the (ξ,η) border. This fact is used to define the two-dimensional worm propagation immediately below.

Using the same parameters as the OWMP and the previous discussion, let the rate of change in the infectious population be defined as

$$\frac{\partial I ( ξ , η , t )}{\partial t} = β \frac{N}{pq} I ( ξ , η , t ) + \frac{φ}{4} ( \begin{matrix}I ( ξ - 1 , η - 1 , t ) + I ( ξ + 1 , η - 1 , t ) + \\ I ( ξ - 1 , η + 1 , t ) + I ( ξ + 1 , η + 1 , t )\end{matrix} ) + \frac{φ}{2} ( \begin{matrix}I ( ξ - 1 , η , t ) + I ( ξ + 1 , η , t ) \\ I ( ξ , η + 1 , t ) + I ( ξ , η - 1 , t )\end{matrix} ) .$$

(10)

Clearly, the expression for two-dimensional case given in (10) is more convoluted than (4). However, the procedure to obtain the closed-form solution of (10) follows the same steps as performed above to obtain the closed form solution in the one-dimensional case.

Let us rewrite (10) as

$$\frac{\partial I ( ξ , η , t )}{\partial t} = AI ( ξ , η , t ) + \frac{B}{4} ( \begin{matrix}I ( ξ - 1 , η - 1 , t ) + I ( ξ + 1 , η - 1 , t ) + \\ I ( ξ - 1 , η + 1 , t ) + I ( ξ + 1 , η + 1 , t )\end{matrix} ) + \frac{B}{2} ( \begin{matrix}I ( ξ - 1 , η , t ) + I ( ξ + 1 , η , t ) \\ I ( ξ , η + 1 , t ) + I ( ξ , η - 1 , t )\end{matrix} ) .$$

where,

$$A = β \frac{N}{pq}$$

and B=φ. Now taking a two-dimensional DTFT along the ξ and η axes gives

$$\frac{\partial M ( ω , θ , t )}{\partial t} = AM ( ω , θ , t ) + \frac{B}{4} M ( ω , θ , t ) ( {e}^{ω + θ} + {e}^{ω - θ} + {e}^{ω - θ} + {e}^{- ω - θ} ) + \frac{B}{2} M ( ω , θ , t ) ( {e}^{θ} + {e}^{ω} + {e}^{- ω} + {e}^{- θ} ) .$$

which can be rewritten as

$$\frac{\partial }{\partial t} M ( ω , θ , t ) = ( \begin{matrix}A + \frac{B}{2} ( cos ( ω ) + cos ( θ ) ) + \\ \frac{B}{4} ( cos ( ω + θ ) + cos ( ω - θ ) )\end{matrix} ) M ( ω , θ , t ) .$$

Assuming that the infection starts with a single infectious node, the solution for the above differential equation is the same as the solution for (5) and that is

$$M ( ω , θ , t ) = exp \{ \begin{matrix}A t + B t ( cos ( ω ) + cos ( θ ) ) + \\ \frac{B t}{2} ( cos ( ω + θ ) + cos ( ω - θ ) )\end{matrix} \} . \qquad ( 11 )$$

To facilitate the inverse transform, t is assumed to be a constant, E=e^{At} and

$$\frac{1}{F} = B t .$$

The above expression can then be rewritten as

$$M ( ω , θ , t ) = E exp . \{ \begin{matrix}\frac{1}{F} ( cos ( ω ) + cos ( θ ) ) + \\ \frac{1}{2 F} ( cos ( ω + θ ) + cos ( ω - θ ) )\end{matrix} \} .$$

Using the Taylor series approximation and considering the first two significant terms obtains

$$\begin{matrix}\tilde{M} ( ω , θ ) \approx E exp \{ \begin{matrix}\frac{1}{F} ( 1 - {ω}^{2} / 2 + 1 - {θ}^{2} / 2 ) + \\ \frac{1}{2 F} ( \begin{matrix}1 - {( ω - θ )}^{2} / 2 + \\ 1 - {( ω + θ )}^{2} / 2\end{matrix} )\end{matrix} \} \\ \approx E exp \{ \begin{matrix}\frac{1}{F} ( 2 - \frac{{ω}^{2} + {θ}^{2}}{2} ) + \\ \frac{1}{2 F} ( 2 - \frac{2 {ω}^{2} + 2 {θ}^{2} + 2 ω θ - 2 ω θ}{2} )\end{matrix} \} .\end{matrix}$$

The above expression can be simplified to

$$\tilde{M} ( ω , θ ) \approx E {e}^{\frac{1}{F} ( 3 - ( {ω}^{2} + {θ}^{2} ) )} .$$

Taking the inverse DTFT gives

$$\begin{matrix}\tilde{I} ( ξ , η ) \approx \int \int E {e}^{\frac{1}{F} ( 3 - ( {ω}^{2} - {θ}^{2} ) ) {e}^{j ξ ω + j η θ}} d ω d θ \\ \approx E {e}^{\frac{3}{F}} \int {e}^{- \frac{{ω}^{2}}{F}} {e}^{j ξ ω} d ω \int {e}^{\frac{- {θ}^{2}}{F}} {e}^{j η θ} d θ .\end{matrix}$$

Using the expression for inverse DTFT of a Gaussian function from (8) obtains

$$\tilde{I} ( ξ , η ) \approx E {e}^{\frac{3}{F}} \frac{F}{2 π} {e}^{- F \frac{{ξ}^{2}}{4}} {e}^{- F \frac{{η}^{2}}{4}}$$

Plugging in the values of A, B, E and F renders the final (approximate) closed-form expression for Ĩ(ξ)≡(ξ,η,t) as

$$I ( ξ , η , t ) \approx \frac{1}{2 πφ t} {e}^{( β \frac{N}{pq} + 3 φ ) t} {e}^{- ( \frac{{ξ}^{2} + {η}^{2}}{4 φ t} )} \qquad ( 12 )$$

The above expression gives a closed-form solution for the TWPM model. It is noteworthy that this solution is quite similar to the OWPM expression given in (9). One obvious difference from (9) is the e^{-η}^{²} term which represents the spread across the vertical axis. Moreover, the term e^{φt} in (9) has been replaced by e^{3φt} in (12). This term represents the observation made in FIG. 4; in other words, each segment has eight neighboring segments as opposed to only two neighboring segments in the one-dimensional case.

In obtaining simulation results for the two-dimensional MANET, a 500×500 m² grid was employed and the total number of nodes was set to N=100000. An infection rate of β=0.2 was used for the simulation. A transmission range of 3 m and a segment size of 10 m was specified for the horizontal axis, i.e., 1≦ξ≦50 and 1≦η≦50. Due to the uniform node distribution, the sub-division of the horizontal and vertical axes results in approximately 40 nodes per grid segment.

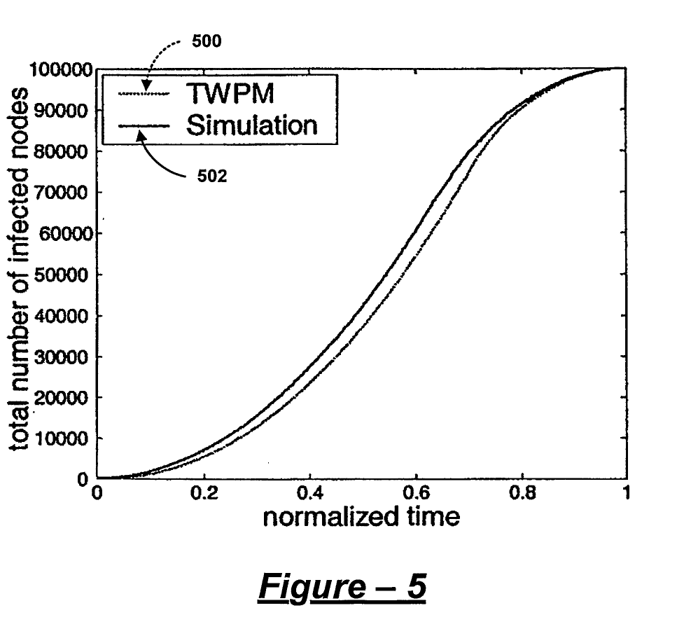

Turning now to FIG. 5, the spread pattern predicted by the TWPM used the same N,β,ξ and η as the simulator. The infectious contacts from border were specified as φ=0.75. The total number of infected nodes given by the TWPM 500 and the simulation 502 are shown in FIG. 5 (the results are plotted against normalized times of the TWPM-predicted and simulated worm propagations.) It can be seen that the TWPM follows the simulation results quite accurately, especially during the initial and the final stages of the infection. The TWPM performance degrades slightly during the middle stage of infection. However, even during the middle stage the TWPM performance is quite close to the simulation results. Thus, it can be concluded that the TWPM provides an accurate model for worm propagation in a two-dimensional MANET.

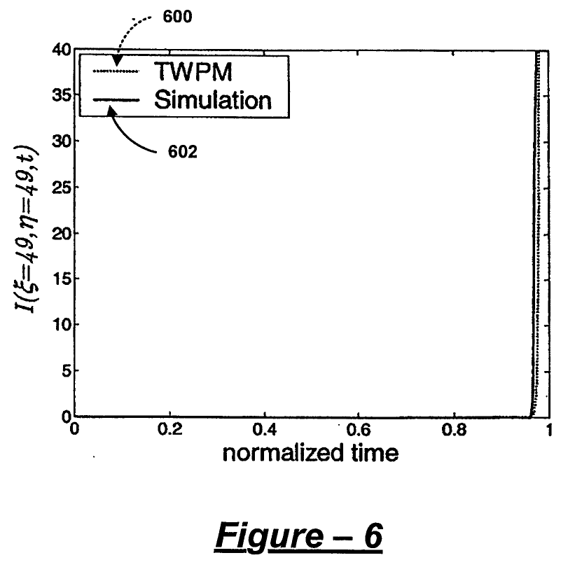

A comparison of FIG. 2 and FIG. 5 reveals that the one-dimensional worm propagation is linear with respect to time while the two-dimensional worm propagation is closer to the spread of Internet worms (i.e., an exponential initial spread followed by a linear increase and finally a slow final spread). This similarity between the worm spread dynamics over a two-dimensional MANET and the Internet can be explained as follows. Recall that the exponential initial spread is due to the availability of large numbers of vulnerable hosts on the Internet. Since an unknown (zero-day) worm is being modeled, even in the two-dimensional MANET case the initial size of the susceptible population is quite large, which results in a fast increase. Similar to the Internet, as time progresses more and more susceptible MANET nodes are infected and therefore the curve assumes a linear increase. The slow final spread in the Internet was attributed to the fact that only few vulnerable hosts remain and it takes more time to search out these vulnerable hosts. The explanation or the slow final spread of MANET worms has precisely the same explanation, that is, in the last stages of the infection almost all MANET nodes are surrounded by neighbors which are already infected thereby resulting in a slow spread. FIG. 6 shows the MANET worm spread in segment (ξ=49,η=49) predicted by the TWPM 600 and substantiated by the simulation 602. This result verifies that the TWPM, in addition to the overall spread, predicts the worm propagation in individual segments quite accurately.

In conclusion, two novel space-time worm propagation models for ad hoc networks have been proposed and evaluated herein, namely the one-dimensional worm propagation model (OWPM) and the two-dimensional worm propagation model (TWPM). Closed-form expressions have been derived for both the models and their correctness has been verified using simulations. The OWPM and the TWPM should provide effective and accurate models for worm propagations over one- and two-dimensional MANET, respectively.

The description of the invention is merely exemplary in nature and, thus, variations that do not depart from the gist of the invention are intended to be within the scope of the invention. For example, the worm propagation models according to the present invention can be used to predict or detect worm spread in the MANET for any purpose. Example purposes are so that humans can actively intervene in worm spread in a more efficient manner. Other purposes are so that applications can deploy automated countermeasures to curb worm spread, observe a quarantine of a network segment, warn a user of potential or approaching worm activity in a segment and degree of threat, or other actions. Such variations are not to be regarded as a departure from the spirit and scope of the invention.

What is claimed is:

1. A worm propagation modeling system for use with a mobile ad-hoc network (MANET), comprising:
an infection detection module operably receiving temporal dynamics information relating to temporal dynamics of worm spread in the MANET and spatial dynamics information relating to spatiality of nodes in the MANET, said infection detection module operably detecting infection in a network segment of the MANET based on the temporal dynamics information and the spatial dynamics information.

2. The system of claim 1, wherein said temporal dynamics information includes infection rate in the MANET.

3. The system of claim 1, wherein said spatial dynamics information includes node density in the network segment.

4. The system of claim 1, wherein said spatial dynamics information includes a number of infectious contacts received from border nodes of neighboring network segments proximate to the network segment.

5. The system of claim 1, wherein said infection detection module detects infection I in a network segment ξ at time t in a one-dimensional MANET according to:
$$I ( ξ , t ) \approx \frac{1}{\sqrt{2 πφ t}} {e}^{( β \frac{N}{n} + φ ) t} {e}^{\frac{{ξ}^{2}}{2 φ t}} ,$$
wherein β is infection rate, N/n is node density in a current, one-dimensional network segment, and φ is a number of infectious contacts received from border nodes of neighboring, one-dimensional network segments.

6. The system of claim 1, wherein said infection detection module detects infection I in a network segment (ξ,η) at time t in a two-dimensional MANET according to:
$$I ( ξ , η , t ) \approx \frac{1}{2 πφ t} {e}^{( β \frac{N}{pq} + 3 φ ) t} {e}^{- ( \frac{{ξ}^{2} + {η}^{2}}{4 φ t} )}$$
wherein β is infection rate, N/pq is node density in the network segment, φ is a number of infectious contacts received from border nodes of neighboring, two-dimensional network segments, and e^{-η}^{²} represents spread across a vertical axis of the two-dimensional MANET.

7. A real-time defense system detecting spread of worms in a network, the system comprising:
a worm spread evaluation module operably performing an evaluation of a worm spread model that captures spatial and time dynamics of worm propagation in the network based on spatiality of nodes of the network.

8. The system of claim 7, further comprising a worm spread mitigation module applying countermeasures against worms in the network based on the evaluation.

9. The system of claim 7, wherein said evaluation module evaluates a worm spread model that models worm propagation based on an assumption that worms in the network employ a next-hop scanning strategy.

10. The system of claim 7, wherein said evaluation module evaluates a worm spread model that models worm propagation based on an assumption that a total number of infected nodes in the network is directly proportional to node density and transmission ranges of nodes in the network.

11. The system of claim 7, wherein said evaluation module evaluates a worm spread model that models worm propagation based on an assumption that mobility of nodes in the network does not have a significant impact on propagation dynamics of a worm in the network.

12. The system of claim 7, wherein said evaluation module evaluates, for a one-dimensional MANET, a worm spread model according to:
$$I ( ξ , t ) \approx \frac{1}{\sqrt{2 πφ t}} {e}^{( β \frac{N}{n} + φ ) t} {e}^{- \frac{{ξ}^{2}}{2 φ t}}$$
wherein β is infection rate, N/n is node density in a current, one-dimensional network segment, and φ is a number of infectious contacts received from border nodes of neighboring, one-dimensional network segments.

13. The system of claim 7, wherein said evaluation module evaluates, for a two-dimensional MANET, a worm spread model according to:
$$I ( ξ , η , t ) \approx \frac{1}{2 πφ t} {e}^{( β \frac{N}{pq} + 3 φ ) t} {e}^{- ( \frac{{ξ}^{2} + {η}^{2}}{4 φ t} )} ,$$
wherein β is infection rate, N/pq is node density in a current, two-dimensional network segment, φ is a number of infectious contacts received from border nodes of neighboring, two-dimensional network segments, and e^{-η}^{²} represents spread across a vertical axis of the two-dimensional MANET.

14. Computer software, comprising machine instructions performing an evaluation of a worm spread model that captures spatial and time dynamics of worm propagation in a mobile ad-hoc network (MANET) based on spatiality of nodes of the MANET.

15. The software of claim 14, wherein said machine instructions apply countermeasures against worms in the MANET based on the evaluation.

16. The software of claim 14, wherein said machine instructions evaluate a worm spread model that models worm propagation based on an assumption that worms in the network employ a next-hop scanning strategy.

17. The software of claim 14, wherein said machine instructions evaluate a worm spread model that models worm propagation based on an assumption that a total number of infected nodes in the network is directly proportional to node density and transmission ranges of nodes in the network.

18. The software of claim 14, wherein said machine instructions evaluate a worm spread model that models worm propagation based on an assumption that mobility of nodes in the network does not have a significant impact on propagation dynamics of a worm in the network.

19. The software of claim 14, wherein said machine instructions evaluate, for a one-dimensional MANET, the following a worm spread model:
$$I ( ξ , t ) \approx \frac{1}{\sqrt{2 πφ t}} {e}^{( β \frac{N}{n} + φ ) t} {e}^{- \frac{{ξ}^{2}}{2 φ t}}$$
wherein β is infection rate, N/n is node density in a current, one-dimensional network segment, and φ is a number of infectious contacts received from border nodes of neighboring, one-dimensional network segments.

20. The software of claim 14, wherein said machine instructions evaluate, for a two-dimensional MANET, the following worm spread model:
$$I ( ξ , η , t ) \approx \frac{1}{2 πφ t} {e}^{( β \frac{N}{pq} + 3 φ ) t} {e}^{- ( \frac{{ξ}^{2} + {η}^{2}}{4 φ t} )}$$
wherein β is infection rate, N/pq is node density in a current, two-dimensional network segment, φ is a number of infectious contacts received from border nodes of neighboring, two-dimensional network segments, and e^{-η}^{²} represents spread across a vertical axis of the two-dimensional MANET.

21. A mobile ad-hoc network (MANET), comprising:
a worm spread evaluation module performing an evaluation of an expression that captures spatial and time dynamics of worm propagation in the MANET based on spatiality of nodes of the MANET;
worm spread mitigation module applying countermeasures against worms in the MANET based on the evaluation.

22. The network of claim 21, wherein said evaluation module evaluates an expression that models worm propagation based on an assumption that worms in the network employ a next-hop scanning strategy.

23. The network of claim 21, wherein said evaluation module evaluates an expression that models worm propagation based on an assumption that a total number of infected nodes in the network is directly proportional to node density and transmission ranges of nodes in the network.

24. The network of claim 21, wherein said evaluation module evaluates an expression that models worm propagation based on an assumption that mobility of nodes in the network does not have a significant impact on propagation dynamics of a worm in the network.

25. The network of claim 21, wherein said evaluation module evaluates, for a one-dimensional MANET, the following expression:
$$I ( ξ , t ) \approx \frac{1}{\sqrt{2 πφ t}} {e}^{( β \frac{N}{n} + φ ) t} {e}^{- \frac{{ξ}^{2}}{2 φ t}}$$
wherein β is infection rate, N/n is node density in a current, one-dimensional network segment, and φ is a number of infectious contacts received from border nodes of neighboring, one-dimensional network segments.

26. The network of claim 21, wherein said evaluation module evaluates, for a two-dimensional MANET, the following expression:
$$I ( ξ , η , t ) \approx \frac{1}{2 πφ t} {e}^{( β \frac{N}{pq} + 3 φ ) t} {e}^{- ( \frac{{ξ}^{2} + {η}^{2}}{4 φ t} )}$$
wherein β is infection rate, N/pq is node density in a current, two-dimensional network segment, φ is a number of infectious contacts received from border nodes of neighboring, two-dimensional network segments, and e^{-η}^{²} represents spread across a vertical axis of the two-dimensional MANET.

27. A machine readable recording medium, comprising:
a set of machine instructions operable to model spatial and time dynamics of worm propagation in a mobile ad-hoc network (MANET) based on spatiality of nodes of the MANET.

28. The recording medium of claim 27, wherein said machine instructions are operable to apply countermeasures against worms in the MANET based on the evaluation.

29. The recording medium of claim 27, wherein said machine instructions model worm propagation based on an assumption that worms in the network employ a next-hop scanning strategy.

30. The recording medium of claim 27, wherein said machine instructions model worm propagation based on an assumption that a total number of infected nodes in the network is directly proportional to node density and transmission ranges of nodes in the network.

31. The recording medium of claim 27, wherein said machine instructions model worm propagation based on an assumption that mobility of nodes in the network does not have a significant impact on propagation dynamics of a worm in the network.

32. The recording medium of claim 27, wherein said machine instructions include, for a one-dimensional MANET, a worm propagation model according to:
$$I ( ξ , t ) \approx \frac{1}{\sqrt{2 πφ t}} {e}^{( β \frac{N}{n} + φ ) t} {e}^{- \frac{{ξ}^{2}}{2 φ t}}$$
wherein β is infection rate, N/n is node density in a current, one-dimensional network segment, and φ is a number of infectious contacts received from border nodes of neighboring, one-dimensional network segments.

34. The recording medium of claim 27, wherein said machine instructions include, for a two-dimensional MANET, a worm propagation model according to:
$$I ( ξ , η , t ) \approx \frac{1}{2 πφ t} {e}^{( β \frac{N}{pq} + 3 φ ) t} {e}^{- ( \frac{{ξ}^{2} + {η}^{2}}{4 φ t} )}$$
wherein β is infection rate, N/pq is node density in a current, two-dimensional network segment, φ is a number of infectious contacts received from border nodes of neighboring, two-dimensional network segments, and e^{-η}^{²} represents spread across a vertical axis of the two-dimensional MANET.

35. An active worm propagation modeling method, comprising:
evaluating an expression that captures spatial and time dynamics of worm propagation in a mobile ad-hoc network (MANET) based on spatiality of nodes of the MANET.

36. The method of claim 35, wherein evaluating the expression includes evaluating an expression that models worm propagation based on an assumption that worms in the network employ a next-hop scanning strategy.

37. The method of claim 35, wherein evaluating the expression includes evaluating an expression that models worm propagation based on an assumption that a total number of infected nodes in the network is directly proportional to node density and transmission ranges of nodes in the network.

38. The method of claim 35, wherein evaluating the expression includes evaluating an expression that models worm propagation based on an assumption that mobility of nodes in the network does not have a significant impact on propagation dynamics of a worm in the network.

39. The method of claim 35, wherein evaluating the expression includes evaluating, for a one-dimensional MANET, the following expression:
$$I ( ξ , t ) \approx \frac{1}{\sqrt{2 πφ t}} {e}^{( β \frac{N}{n} + φ ) t} {e}^{- \frac{{ξ}^{2}}{2 φ t}}$$
wherein β is infection rate, N/n is node density in a current, one-dimensional network segment, and φ is a number of infectious contacts received from border nodes of neighboring, one-dimensional network segments.

40. The method of claim 35, wherein evaluating the expression includes evaluating, for a two-dimensional MANET, the following expression:
$$I ( ξ , η , t ) \approx \frac{1}{2 πφ t} {e}^{( β \frac{N}{pq} + 3 φ ) t} {e}^{- ( \frac{{ξ}^{2} + {η}^{2}}{4 φ t} )}$$
wherein β is infection rate, N/pq is node density in a current, two-dimensional network segment, φ is a number of infectious contacts received from border nodes of neighboring, two-dimensional network segments, and e^{-η}^{²} represents spread across a vertical axis of the two-dimensional MANET.

41. A method of developing a model for real-time prediction of worm propagation in a mobile ad-hoc network (MANET), the method comprising:
making a first assumption that worms in the network employ a next-hop scanning strategy;
making a second assumption that a total number of infected nodes in the network is directly proportional to node density and transmission ranges of nodes in the network;
making a second assumption that mobility of nodes in the network does not have a significant impact on propagation dynamics of a worm in the network; and
developing a worm spread model based on the first assumption, the second assumption, and the third assumption, wherein the worm spread model captures spatial and time dynamics of worm propagation in the MANET based on spatiality of nodes of the MANET.

42. The method of claim 41, wherein developing the worm spread model includes, for a one-dimensional MANET, developing the word spread model according to:
$$I ( ξ , t ) \approx \frac{1}{\sqrt{2 πφ t}} {e}^{( β \frac{N}{n} + φ ) t} {e}^{- \frac{{ξ}^{2}}{2 φ t}}$$
wherein β is infection rate, N/n is node density in a current, one-dimensional network segment, and φ is a number of infectious contacts received from border nodes of neighboring, one-dimensional network segments.

43. The method of claim 41, wherein developing the worm spread model includes, for a two-dimensional MANET, developing the worm spread model according to:
$$I ( ξ , η , t ) \approx \frac{1}{2 πφ t} {e}^{( β \frac{N}{pq} + 3 φ ) t} {e}^{- ( \frac{{ξ}^{2} + {η}^{2}}{4 φ t} )}$$
wherein β is infection rate, N/pq is node density in a current, two-dimensional network segment, φ is a number of infectious contacts received from border nodes of neighboring, two-dimensional network segments, and e^{-η}^{²} represents spread across a vertical axis of the two-dimensional MANET.
